(19) United States
(12) Patent Application Publication
(10) Pub. No.: US 2016/0113306 A1
(43) Pub. Date: Apr. 28, 2016

(54) ANIMAL FEED PRODUCTS ADAPTED TO DETER WILD BIRD CONSUMPTION AND METHODS OF MAKING AND FEEDING SAME

(71) Applicant: PURINA ANIMAL NUTRITION LLC, Shoreview, MN (US)

(72) Inventors: Catherine M. Klein Bradley, Washington, MO (US); Jill A. Davidson, Washington, MO (US)

(21) Appl. No.: 14/522,202

(22) Filed: Oct. 23, 2014

(51) Int. Cl. A23K 1/16; A01M 29/06

(52) U.S. Cl. CPC A23K 1/1606; A01M 29/06

(57) ABSTRACT

Deterring wild bird consumption of animal feed involves, in a location accessible to wild birds, providing non-avian animals an animal feed particle having nutrients susceptible to wild bird consumption and a color that is effective to reduce the wild bird consumption of the animal feed particle. The animal feed particle may be provided alone or in combination with other feed components and fed to a target animal. Producing the particle may involve combining a selected color with nutrients susceptible to wild bird consumption and forming the particle, such as through extruding or pelleting.

### TECHNICAL FIELD

Implementations relate generally to animal feed products, methods of making the products and feeding systems effective to deter wild bird consumption of such animal feed products.

### BACKGROUND

In 2012, USDA Animal and Plant Health Inspection Service (APHIS) investigators reported commercial dairies in Pennsylvania, New York and Wisconsin suffered from feed loss and bird fecal contamination throughout the year, but at a higher extent during the first quarter of the year. European starlings are the most destructive species, but other wild birds are also to blame for these problems. Dairies reporting no bird problems, such as those that take affirmative measures to deter wild birds, spent $4.92 on feed cost per hundredweight of milk. In contrast, dairies reporting bird populations greater than 10,000 spent $2.07 more on feed cost per hundredweight. For example, a starling weighing 85 grams can eat about 2 pounds of feed per month. Where ruminant feed cost is 13 cents per pound of dry matter, this equates to 26 cents per bird per month. When producers manage large facilities, thousands of birds may scavenge animal feed resulting in tens of thousands of dollars of lost feed per year.

It is believed that wild birds prefer energy-dense ingredients, particularly starch, in feedlot and dairy rations. Starch feed ingredients, however, come at a higher cost, and when birds sort feed, starch loss will be incurred, which alters the composition of the animal's diet, and which can reduce animal performance such as meat and milk production.

Bird-control strategies differ in terms of their cost and effectiveness. For example, feed treated with methyl anthranilate has been found to deter wild birds from consuming these feeds. However, cost concerns with this additive have resulted in a search for alternative methods to deterring wild bird consumption of animal feed.

### SUMMARY

The present disclosure provides methods of deterring wild bird consumption of feeds containing nutrients susceptible to wild bird consumption, methods of producing a feed material adapted for deterring wild bird consumption, and a feed product with a composition adapted for deterring wild bird consumption. Feeds that are otherwise susceptible to wild bird consumption generally include non-avian animal feeds including, but not limited to, feeds for livestock animals, zoo animals, and companion animals. Each of these animal feeds may include nutrients susceptible to wild bird consumption such as starches including sugars, protein and some fats. However, it has been discovered that by providing animal feeds of a particular color results in a product that is less appealing for ingestion by wild birds, and enables the feed to be available to the animal for which it is intended without negatively altering the feeding patterns of the target animal, thus saving on animal feed costs and resulting in a more predictable nutrient intake by the animals.

According to one implementation, a method of deterring wild bird consumption of animal feed involves, in a location accessible to wild birds, providing non-avian animals an animal feed particle having nutrients susceptible to wild bird consumption and a color that is effective to reduce the wild bird consumption of the animal feed particle. The color of the animal feed particle being one or more of:

| | | | |
|---|---|---|---|
| black iron oxide having approximate | 22.93, | 0.74, | 6.24, |
| respective L*a*b* values of: | | | |
| oxide having approximate respective | 41.77, | 5.48, | 26.11, |
| L*a*b* values of: | | | |
| tannin dye having approximate respective | 39.89, | 8.23, | 26.82, |
| L*a*b* values of: | | | |
| green having approximate respective | 36.04, | −11.58, | 18.07, or |
| L*a*b* values of: | | | |
| forest green having approximate respective | 29.13, | −5.16, | 12.28, |
| L*a*b* values of: | | | |

where the L*a*b* values are based on a CAE 1976 L*a*b* color scale in which L* is a measure of lightness approximately as the eye would evaluate it, and varies from 100 for perfect white to zero for black, a* measures redness when positive, gray when zero and greenness when negative, and b* measures yellowness when positive, gray when zero and blueness when negative.

According to another implementation, a method of deterring wild bird consumption of animal feed involves, in a location accessible to wild birds, providing a feed ration to non-avian animals, the feed ration comprising feed components and animal feed particles comprising, nutrients susceptible to wild bird consumption and a color effective to reduce wild bird consumption of the animal feed particle relative to the feed components in the feed ration.

In yet another implementation, a method of forming a feed material adapted for deterring wild birds from consuming feed material otherwise susceptible to consumption by the wild birds involves forming an animal feed material comprising nutrients susceptible to wild bird consumption and a color that is effective to reduce the wild bird consumption of the animal feed. The color of the animal feed particle being one or more of the colors provided above.

### BRIEF DESCRIPTION OF THE DRAWINGS

FIG. 1 illustrates a bar chart of wild bird consumption results of a control animal feed product and consumption of test products relative to the control product, in which the test products were formulated according to implementations of the present disclosure.

FIG. 2 illustrates a bar chart of wild bird consumption results of an animal feed product formulated according to the present disclosure used as a control, and consumption of other test products formulated according to the present disclosure relative to the control product.

FIG. 3 illustrates a bar chart of wild bird consumption results of an animal feed product formulated according to the present disclosure used as a control, and consumption of other test products formulated according to the present disclosure relative to the control product.

FIG. 4 illustrates a bar chart of wild bird consumption results of a control animal feed product and consumption of test products relative to the control product, in which the test products were formulated according to implementations of the present disclosure.

FIG. 5 illustrates a bar chart of consumption results of two test products formulated according to the present disclosure relative to one another.

FIG. 6 illustrates a bar chart of wild bird consumption results of a control animal feed product and consumption of a test product relative to the control product, in which the test product was formulated according to implementations of the present disclosure.

### DETAILED DESCRIPTION

Overview

Methods of deterring wild bird consumption of animal feed otherwise susceptible to wild bird consumption involve providing an animal feed with a color effective as a consumption deterrent by the wild birds. Deterring consumption reduces wild bird scavenging of feed particles from target animal feeds, making more of the particles available for the target animals. Feeds that are otherwise susceptible to wild bird consumption generally include non-avian animal feeds including, but not limited to, feeds for livestock animals, zoo animals, companion animals and wildlife. Livestock animals may include ruminants and pigs of any age. Zoo animals may include zebras, camelids, primates, kangaroos, bear, deer, reindeer, elk, elephants, exotic felines, exotic canines. Companion animals may include dogs, cats, rabbits and horses. Wildlife may include bear, deer, reindeer, elk, or other mammals that may be hunted. These animal feeds generally include nutrients susceptible to wild bird consumption, especially starch. Other nutrients generally attractive to the wild birds also include sugars and some fats.

Animal Feed Compositions having a Selected Color

Animal feed compositions of the present disclosure contain a colorant to impart a selected color to the animal feed for deterring wild bird consumption of the feed composition. The colorants that may be used in the implementations of the present disclosure may be dyes such as those that are generally regarded as safe (GRAS), chromic oxide, food products containing natural colors, other color-containing compositions and combinations thereof. It has been discovered that when an animal feed composition is imparted with one of the colors listed in Table 1, wild birds are deterred from consuming such animal feed.

TABLE 1

| | L* | a* | b* |
|---|---|---|---|
| Black Iron Oxide | 22.93 | 0.74 | 6.24 |
| Oxides to appear like 2% Tannin | 41.77 | 5.48 | 26.11 |
| 2% Tannin | 39.89 | 8.23 | 26.82 |
| Green | 36.04 | −11.58 | 18.07 |
| Forest Green | 29.13 | −5.16 | 12.28 |

The color analysis performed to reach the L*a*b* color space values in Table 1 used a CIE 1976 Pell* color scale, where:

L* measures lightness approximately as the eye would evaluate it, and varies from 100 for perfect white to zero for black;

a* measures redness when positive, gray when zero and greenness when negative; and

b* measures yellowness when positive, gray when zero and blueness when negative.

Because L*a*b* color is designed to approximate human vision, those skilled in the art will understand the Path* values of Table 1 may be approximate values within +/−2.

Black iron oxide colorant may be obtained from Prince, 21 West 46th Street, floor 14, New York, N.Y. 10036. Oxides that appear as 2% tannin may be obtained from Prince. Tannin may be obtained from Tanin Sevnica, Hermanova cesta 1, 8290 Sevnica, Slovenia. Green colorant may be obtained from Colorcon, Colorcon, Inc. 275 Ruth Road, Harleysville, Pa. 19438. Further, blends colorants may be used to prepare other colorants such as forest green. Any or all of these colors may impart a color to the animal feed composition that serves as a deterrent to wild bird consumption.

In addition to colorants in the animal feed compositions of the present disclosure, the compositions may contain a combination of fat, starch and/or protein. The nutrient profiles of the animal feed compositions may vary based on the targeted animal. Fat contained in the animal feed includes fats derived from animals and vegetables. Animal-derived fats may include beef tallow, fish oil, other animal oils or fats and combinations thereof. Vegetable-derived fats may include soybeans, soybean oil, corn, corn oil, palm oil, palm stearin, coco butter, other vegetable oils or fats and combinations thereof. The amount of fat in the animal feed may range from 2 to about 60 percent by weight of the feed. Particularly, even feeds formulated with a relatively low amount of fat, such as feeds containing about 2 to about 20 percent by weight of the feed, may be attractive to wild birds. Feeds for other target animals, may contain fat at about 20 to about 60 percent by weight of the feed, about 45 to about 55 percent by weight of the feed, about 50 to about 55 percent by weight of the feed, about 50 percent by weight of the feed, or about 55 percent by weight of the feed, depending on the animal targeted for ingestion of the feed. Saturated fat may account for between 20 and 100 percent of the total fat, about 20 to 60 percent of the total fat, about 50 percent of the total fat, about 50 to 100 percent of the total fat, about 85 to 100 percent of the total fat, about 85 percent of the total fat, or about 100 percent of the total fat.

Starch in the animal feeds may be derived from a variety of sources including grain products such as corn, wheat, barley, oats, sorghum, tapioca, isolated dry or wet milled starch, their milled components and combinations of these, and any of these starch components may be susceptible to wild bird consumption. The amount of starch may account for at least about 20 percent by weight of the feed, between about 20 percent by weight and about 30 percent by weight or about 30 to about 40 percent by weight of the feed, or greater than 30 percent by weight of the feed.

Protein in the animal feed may be sourced from plant protein products such as soybean meal, cottonseed meal and corn gluten meal. Other proteinaceous sources include other oil seed meals such as palm meal; animal by-product meals such as meat meal, poultry meal, blood meal, feather meal and fishmeal; plant by-product meals such as wheat middlings, soybean hulls and corn by-products; and microbial protein such as torula yeast and brewer's yeast. Any of the protein sources may be susceptible to wild bird consumption. The amount of protein in the animal feed may be between about 1 percent by weight and about 30 percent by weight of the animal feed, and more particularly may be about 5 to 15 percent by weight of the feed.

The animal feed compositions may include other additives without affecting the properties of the animal feed. Additives may include amino acids, vitamins, minerals, nutraceuticals, pharmaceuticals, flavorings such as molasses, and various processing aids such as talc and calcium carbonate. According to certain implementations, the animal feeds of the present disclosure may be free of methyl anthranilate.

Methods of Producing the Animal Feed Compositions Having a Selected Color

Animal feeds having a selected color may be provided as a particle (e.g., nugget or pellet), and may be produced through extrusion or pelleting processes. For example, nutritional components and colorants may be mixed and forced by a spinning screw through a restricted orifice in an extrusion process where the mixture may be subjected to high temperatures and pressures. A ribbon exiting the extruder may expand and be sliced into particles such as nuggets. In addition or alternatively, exemplary methods of extruding animal feeds are disclosed in a co-pending U.S. application entitled “High Fat Feed Particles,” having application Ser. No. 12/822,376 and filed on Jun. 24, 2010, the contents of which are herein incorporated by reference in their entirety for any useful purpose.

In another example, nutritional components and colorants may be formed into a meal and fed into a pellet mill where the meal is compressed through the holes defined by the die. During this compression, the meal is heated due to friction and the added mechanical energy. The compressed meal exits the die in a ribbon that may be sliced transversely to form particles such as pellets. Upon drying, the particles may have a color effective to deter wild birds from consuming the particle, as described.

In addition or alternatively, the particles may be coated with colorants that provide the particles with an exterior coating of a color that is effective to deter wild bird consumption. For instance, the particles may be sprayed with a dryable colorant solution or a colorant powder.

The amount of colorant added to the nutritional components during extrusion or pelleting or the amount used to coat the particles varies and depends on the color naturally imparted to the particle by the feed components forming the particle. Those skilled in the art will appreciate that reaching a particle having a color with an approximate L*a*b* value in Table 1 or combination thereof requires a level of experimentation that is not undue.

Methods of Feeding Animal Feed Compositions Having a Selected Color

The animal feed compositions having a selected color may be provided to animals in confined settings such as barns, feed lots, and some ranches; in semi-confined settings such as wilderness preserves, farms and some ranches; and in open settings such as in wooded areas, fields or prairies. In each of these settings, the animal feeds of the present disclosure are distributed in areas that are accessible to wild birds. For instance, feed troughs may be positioned outdoors or in sheltered spaces, and such placement of the troughs makes the animal feed compositions of the present disclosure accessible to wild birds. In another example, animal feed compositions may be deposited in an outdoor setting as a way to attract a target animal, such as deer, other wild ruminants, bears, and so on, making the animal feed accessible to wild birds.

When the animal feed compositions are fed in a confined or semi-confined setting, the animal feed compositions may be provided alone or in combination with a feed ration (e.g., a total mixed ration). For instance, for ruminants, in addition to the animal feed composition having a selected color, the ruminant feed ration may include feed components such as corn silage, legume silages, alfalfa hay, mixed hays (e.g., legumes and grasses) grains (e.g., soybeans, corn, milo), grain mixtures, grain meals, formula feeds tailored for ruminants (e.g., lactating ruminants, pre-partum ruminants, beef cattle), and nutritional supplements (e.g., fatty acids and vitamins). Pig feed rations may additionally include grains such as corn, milo, wheat, oats, and/or barley and a source of protein such as soybean meal, fish meal and/or other sources of protein, along with macronutrients and vitamins. Horse feed rations may additionally include feed components such as hays (e.g., alfalfa, clover, Timothy and combinations thereof), oats, corn, barley, milo, soybean meal, linseed meal, formula feeds tailored for horses (e.g., lactating horses, pre-partum horses, colts, geldings, stallions), macronutrients and vitamins.

Feed rations including the animal feed compositions having a selected color may be provided on a daily basis, or multiple times per day, e.g., two, three or four feedings per day. Where multiple feedings are provided to the animal as part of a daily feed ration, the animal feed composition may be present in some or all of the feedings. In addition, the feed ration may be provided ad libitum.

As described, the animal feed compositions having a selected color may be offered alone or in combination with other feed ration components. Further, wild bird consumption of feed ration components such as hay and grains silage is common. When animal feed particles are included in the feed ration, wild birds tend to favor consumption of the particles (e.g., by sorting) but also consume other feed ration components. As a result of the feed loss, intake by the target animal is unpredictable. For instance, when a feed ration including corn silage, hay and animal feed particles without a colorant is provided in a location accessible to wild birds, the presence of the animal feed particles results in more of the feed ration being consumed compared to when a feed ration without the animal feed particles is provided in substantially the same setting, leaving fewer nutrients available to the target animal. This makes feeding a target animal difficult because feed particles are tailored to the animal's diet and needed for proper nourishment. When the same animal feed particle is provided with a selected color and used in the same feed ration, wild bird consumption of the feed ration is reduced relative to the ration containing the particles without a colorant. In one study conducted over 6 days in which rations were offered in a location accessible to wild birds for about 4 consecutive hours each day with pans rotated between locations (see Adaptation phase), consumption of a feed ration with particles containing a green dye colorant (L* 36.04, a* −11.58, b* 18.07) was reduced by about 10%-15% relative to a feed ration with particles not containing a colorant (L* 52.52, a* 0.67, b* 33.35), meaning more nutrients, including particles are available to the target animal, resulting in a more predictable feed intake. In addition, because animal feed compositions, e.g., particles, are formulated for a target animal, the cost of producing these feeds is increased relative to other feed ration components that require no or low processing prior to offering to the target animal. In many instances, the cost of animal feed compositions tailored to a nutrient requirement of the animal is the most expensive component of the animal's feed ration. By forming the animal feed compositions with a selected color that is effective to deter their consumption by wild birds to at least a lower level compared to a feed ration containing the same particle but without a colorant, the cost of feeding the target animal may be reduced.

When provided as a particle, the selected color of the particle may deter wild bird consumption of the particle for at least 6 consecutive hours. The deterrent effect may additionally or alternatively last for least 12 hours, or longer, segmented over the course of two or more consecutive days. The deterrent effect involves a reduction of loss of the particle from wild bird consumption, meaning that more of the particle can be consumed by the target animal. The level of reduced consumption may be at about 60% to 80% over these time periods relative to a particle not containing a colorant. Although wild birds may ingest the particles, the rate of loss may be reduced to levels where the nutrient intake of the target animal can be more accurately predicted.

The deterrent effect of the animal feed composition having a selected color may also extend over a number of days. For instance, providing a particle having a selected color in locations accessible to wild birds may deter wild bird consumption over the course of about 2, 3, 4 or 5 consecutive days when the compositions are available for about 4 to 6 consecutive hours daily, with an average reduction in loss being at least 10%, 15%, 20% or higher.

According to certain implementations, the selected color of the animal feed particle may be a 2% tannin additive (L* 39.89, a* 8.23, b* 26.82), a dye to appear to contain a 2 wt % tannin additive (L* 41.77, a* 5.48, b* 26.11), a black iron oxide dye (L* 22.93, a* 0.74, b* 6.24) or green dye additive (L* 36.04, a* −11.58, b* 18.07). Offering the particle over the course of 2, 3, 4 or 5 consecutive days and making the particle available for 2-5 consecutive hours each day may result in a 10%, 20%, 30%, 40%, 50%, 60%, 70%, 80%, 90% or higher reduction of loss by wild birds on a daily basis and/or over five consecutive days. In some examples, this may result in a wild bird consumption rate of up to about 90%, 80%, 70%, 60%, 50%, 40%, 30%, 20% and as low as about 10% or less, on a daily basis and/or over five consecutive days.

In certain implementations, the selected color of the animal feed particle may be forest green (L* 29.13, a* −5.16, b* 12.28). In this example implementation, wild bird consumption of the particle in locations accessible to wild birds may be reduced by about at least 15%, 20% or higher, or up to 25% over the course of 6 consecutive days when the forest green particle is available for 2.5-4.5 consecutive hours per day compared to a particle containing no colorant (L* 52.52, a* 0.67, b* 33.35).

Target animals offered the colored feed particle do not alter their feeding patterns as a result of the color change in the feed, and accordingly, adding a selected color to animal feed particles may deter wild bird consumption while at the same time not negatively impacting the consumption of the particles in a TMR or in component fed systems.

Implementations of the present disclosure are more particularly described in the following studies that are for illustrative purposes only. Numerous modifications and variations are within the scope of the present disclosure as will be apparent to those skilled in the art.

Studies

Adaptation Phase:

The adaptation phase established a feeding location where wild birds became acclimated to consumption of feed products. In this phase, pans filled with animal feed particles in nugget form containing a combination of fat (e.g., animal-derived fat and/or plant-derived fat), grain products (e.g., corn), plant protein products (e.g., soybean meal), and macronutrients (calcium carbonate, phosphorous), with a nutrient profile of about 50 wt % fat, about 8 wt % protein, about 38 wt % starch, about 1.5 wt % crude fiber, about 2.0 wt % acid detergent fiber, and about 0.6 wt % macronutrients and L* 52.52, a* 0.67, b* 33.35. The pans containing the animal feed particles were placed outside the dairy barn in various locations until a site was found where birds consumed the particle. Once a site was identified, four treatment testing pans were developed and were each filled with five pounds of the particle. Consumption was measured for seven days until pans were being consistently consumed. As a result, bird consumption increased over time from 1.67 lbs./pan to 4.78 lbs./pan over the course of 7 days. Additionally the birds began to eat the animal feed particle in a shorter period of time.

Consumption was measured for five consecutive days by leaving the pans out for birds for 2-5 consecutive hours during the morning. The pan locations were changed daily, rotating between four different locations.

Study 1:

Study 1 tested whether the inclusion of brown iron oxide, black iron oxide, or tannin to the animal feed particle in nugget form influenced the intake of animal feed particle by wild birds.

Procedure: In this study, pans were filled with either 5 pounds of the control animal feed particle (control) (L* 52.52, a* 0.67, b* 33.35), with 5 pounds of the animal feed particle having the same composition as the control but with a brown iron oxide additive, with 5 pounds of the animal feed particle having the same composition as the control but with a black iron oxide additive (L* 22.93, a* 0.74, b* 6.24), or with 5 pounds of the animal feed particle having the same composition as the control but with a 2 wt % tannin additive (L* 39.89, a* 8.23, b* 26.82). These pans were placed in the positions identified during the adaptation phase and consumption was measured for five consecutive days by leaving the pans out for 2-5 consecutive hours during the morning, rotating the pans daily so that each location received three of the particle types once and one of the particle types twice. Weigh backs were recorded daily.

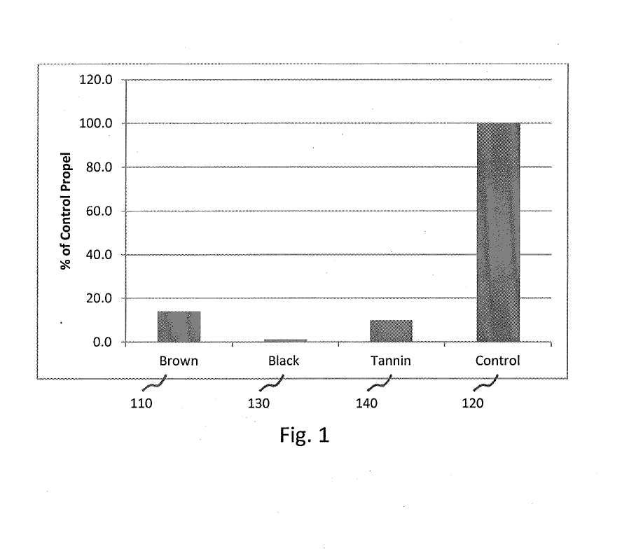

Results and Summary: The results were consistent over the five days of treatment. Wild birds preferred the control feeding pan over any of the other three options. Of the three, the treatment with black iron oxide additive was the most effective additive; no more than 2.02% of the amount of the treatment was consumed when compared to the amount of the control that was consumed each day. Treatments with tannin additive and brown iron oxide additive were effective, but less so, and less consistently than black iron oxide. The amount of the treatment with the tannin additive consumed ranged from 0.44% to 17.81% of the amount of the control pan consumed, and the amount of the treatment with the brown iron oxide additive consumed ranged from 1.06% to 27.94% of the amount of the control pan consumed. As reflected in FIG. 1, on average, the birds consumed the treatment with the brown iron oxide additive (110) at 14% of the control (120) in which the control was consumed at 94% of the amount offered, the treatment with the black iron oxide additive (130) at 1.2% of the control (120), and the treatment with the tannin additive (140) at 10% of the control (120).

Study 2: Given the success of the tannin additive to deterring wild bird consumption, this additive and its color were further studied. Pans were filled with 5 pounds of each of the animal feed particle in nugget form having the same composition as the control in Study 1 with the exception of the particle additionally containing: a 2 wt % tannin additive (control) (L* 39.89, a* 8.23, b* 26.82), a dye to appear to contain a 2 wt % tannin additive (L* 41.77, a* 5.48, b* 26.11), a 1 wt % tannin additive, and a 0.5 wt % tannin additive. These pans were placed in the positions identified during the adaptation phase and consumption was measured for five consecutive days by leaving the pans out for about 2-4 consecutive hours during the morning, rotating the pans daily as described above in Study 1. Weigh backs were recorded daily.

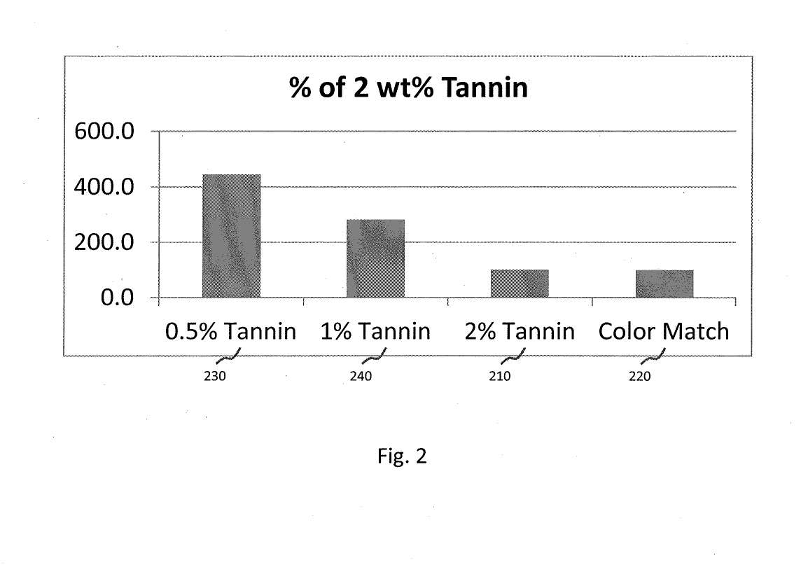

Results: As illustrated in FIG. 2, relative to the control containing 2 wt % tannin additive (210), on average, the birds consumed approximately the same amount of animal feed particle dyed to appear to contain a 2 wt % tannin additive (220) (color match), which was respectively about 21% and 23% of the amount offered, while the birds consumed 444.5% of the particle containing the 0.5 wt % tannin additive (230), which was about 71% of the amount offered, and 281% of the particle containing the 1 wt % tannin additive (240), which was about 47% of the amount offered. In Study 2, the birds preferred a particle with 0.5 wt % and 1.0 wt % tannin over the control containing 2 wt % tannin or the particle dyed to appear to contain a 2 wt % tannin additive. Given the relative reduction of intake of the particle dyed to appear to contain a 2 wt % tannin additive, the color imparted by the tannin at 2 wt % appears to be effective to deter wild bird consumption.

Study 3:

Given the success of the tannin additive and its corresponding color to deterring wild bird consumption, the 2 wt % tannin color additive (color match from FIG. 2) was further studied along with safflower oil and green dye to assess whether the color of the particle in nugget form containing these treatments has an effect on animal feed particle consumption by wild birds.

Procedure: In this study, one pan was filled with 5 pounds of the animal feed particle dyed to appear to contain a 2% tannin additive (L* 41.77, a* 5.48, b* 26.11) (control), two pans with 5 pounds of the animal feed particle with the 0.5% tannin additive blended with oxide to appear like the animal feed particle with 2% tannin additive, one pan with 5 pounds of the animal feed particle with safflower oil additive, and one pan filled with 5 pounds of the animal feed particle with green dye additive (L* 36.04, a* −11.58, b* 18.07). Pan placement, amount of particle added to the pans, the number of days in the study, the duration which the pans were left outside per day, the rotation of the pans, and weigh backs were the same as described in Study 1.

Results: Similar to Study 1, in Study 3 there was some inconsistency on the first day of the study, but the remaining four days were fairly consistent with each other.

On days 2-5 of the test, the birds preferred the two 0.5 tannin plus oxide pans at 150%-300% of the control pan. The safflower oil additive pan was consistently consumed at 28.2% to 62% of the control over the five days; however, there was one outlier on day 4, in which safflower oil was preferred at 445.1% of the control. On this day the amount of the control consumed was abnormally low, which artificially inflated every other data point. The green dye additive pan, however, scored consistently. The birds did not consume the animal feed particle containing the green dye additive at more than 5% of the control on any day recorded.

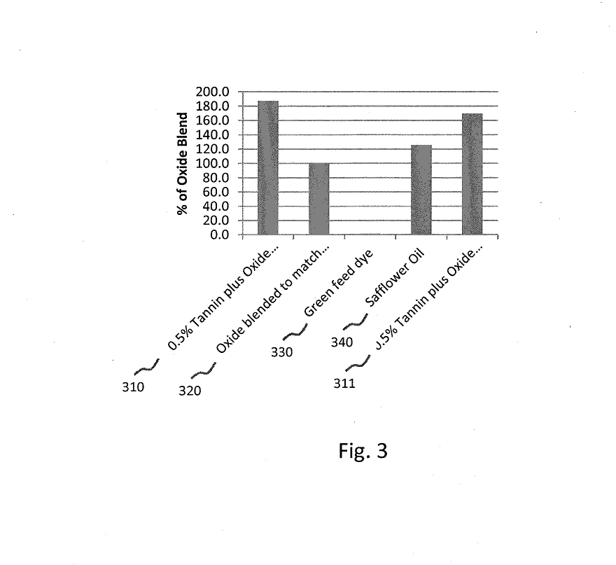

FIG. 3 illustrates the average relative feeding rates, however, there was high variability and days 1 and 4 have artificially skewed the averages of every pan upwards, particularly the safflower oil pan. Day 4, in particular, should be discounted as being inconsistent with the other days. As illustrated in FIG. 3, on average, the birds consumed the two 0.5 tannin plus oxide pans (310, 311) at 190% and 170% of the control pan (320), which was 86% and 68% of the amount offered; the green dye pan (330) at less than 5% of the control pan (320), which was 52% of the amount offered; and the safflower oil pan (340) at 125% of the control pan (320), which was 42% of the amount offered. In Study 3, the birds preferred the low tannin/oxide blend to the control with an oxide blend but with no tannin. They also consumed the animal feed particle with safflower oil at a greater rate than the control. The birds almost completely avoided the animal feed particle treated with green feed dye.

Study 4:

The color of the animal feed particle in nugget form was further studied to determine how color affects consumption by wild birds.

Procedure: Two pans of the animal feed particle having the same composition as the control particle in Study 1 were treated with green feed dye (L* 36.04, a* −11.58, b* 18.07) and two pans with the composition as in the control of Study 1 were treated with black iron oxide (L* 22.93, a* 0.74, b* 6.24) and were offered for approximately five consecutive hours in the morning. Five pounds of treated particles were added to each pan at the beginning of the measurement period and at the end of each day weigh backs were recorded. Pan placement, amount of particle added to the pans, the number of days in the study, the duration which the pans were left outside per day, the rotation of the pans, and weigh backs were the same as described in Study 1.

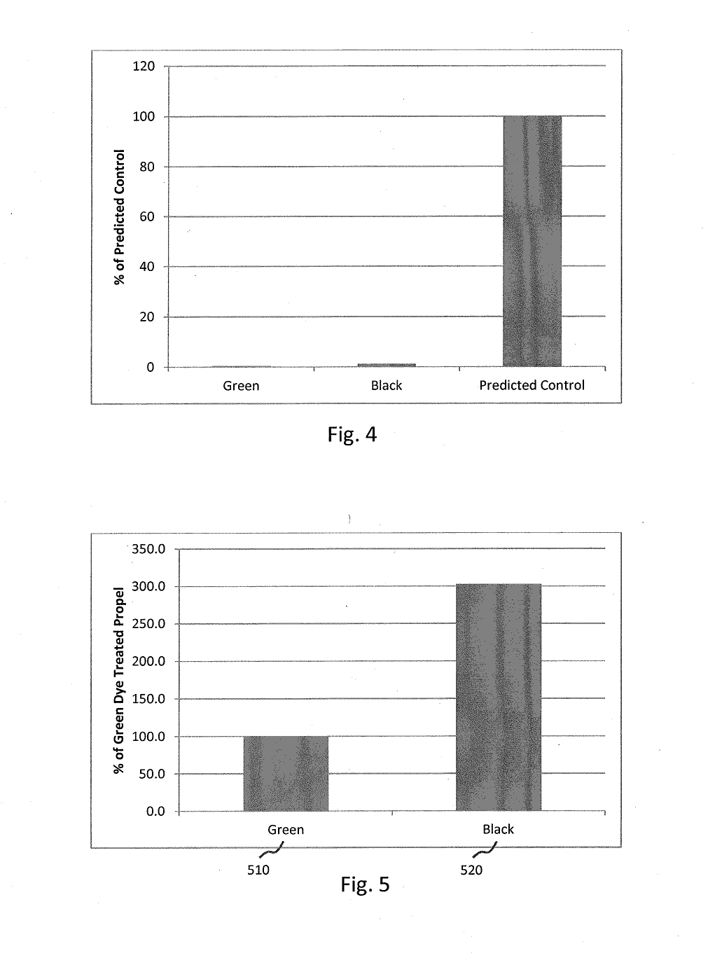

Results: Both treatments were effective in minimizing consumption of the animal feed particles by wild birds when compared to the predicted control, which is the amount documented to have been consumed in the same time period in prior studies, as illustrated in FIG. 4. In Study 4, the wild birds consumed 12% of the green feed dye treatment offered and 32% of the black iron oxide treatment offered. Accordingly, and as illustrated in FIG. 5, the green feed dye treatment (510) was slightly more effective than the black iron oxide treatment (520) with approximately one-third the amount of green consumed as the black iron oxide treatment, but both treatments were effective in minimizing wild bird consumption of the animal feed particles.

Study 5:

The objective of this study was to determine whether the color of the animal feed particle as part of a total mixed ration (“TMR”) affects consumption of the animal feed particles by wild birds.

Procedure: In this study, one pan was filled with TMR, which included the control animal feed particle from Study 1 (L* 52.52, a* 0.67, b* 33.35) mixed with silage (control). A total of 100 pounds of TMR was offered. Another pan was filled with TMR made with the animal feed particles having the same composition as the control with the addition of green feed dye (L* 36.04, a* −11.58, b* 18.07). Again, 100 pounds of TMR was offered. Consumption was measured for six days (with one of the days studied following a 2-day interruption in the study) by leaving the pans out for birds for 5 consecutive hours during the morning, switching the pans back and forth alternately between locations every day.

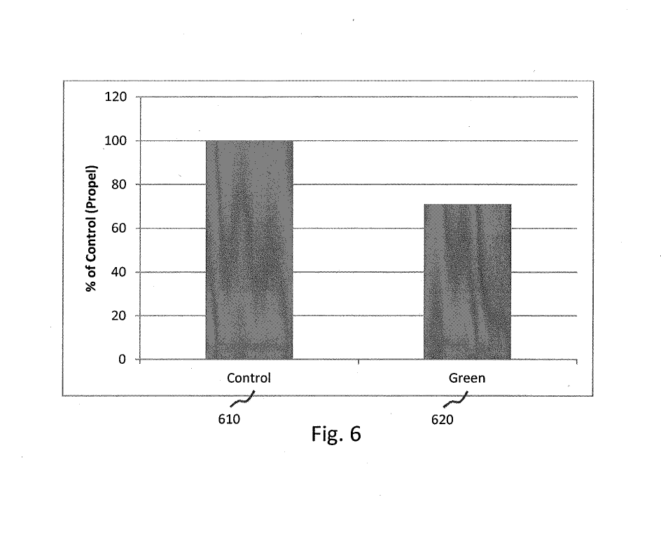

Results: The amount of animal feed particle consumed by the wild birds varied depending on location. On average, however, this study showed that birds preferred the untreated control over the green dye-treated particles, and as illustrated in FIG. 6, compared to the control ration containing the control particles (610), the birds consumed about 71% as much of the green dye-treated particles in the TMR (620). This study suggests that green dye added to the animal feed particles may have a smaller effect on the amount consumed by birds when incorporated into a TMR, however responses were highly variable and location preferences appeared to influence consumption, which limits the conclusions that can be drawn from this study.

Study 6:

The objective of this study is to determine if cows would consume animal feed particles dyed green. As with studies 1-5, the animal feed particles of Study 6 contained the same nutrient profile as the control feed particles in the adaptation phase but with the addition of green dye.

Procedures: Using 16 cows at various stages of lactation, were studied in a side-by-side comparison over four consecutive days. Each cow had a choice of a feeding door providing access to two pans: pans 1 and 2. Once the door was selected, then a head-lock mechanism retained the cow's head in the feeding area for about 6 minutes in order to allow the cow to consume about half of the ration offered from the pans. An acclimation period of three days used a control mix in both pans in order to train cows to the two-pan system. The four day testing period immediately followed the acclimation period. Pans containing ration A or B were rotated each day as to which side of the door the pans were located (right or left) as follows: day 1: ration 1 on right; day 2: ration 1 on left; day 3: ration 1 on right; and day 4: ration 1 on left. This procedure of an adaptation phase immediately followed by a testing period was conducted for a grain feeding study and a TMR study. For the grain feeding study, test pans contained 5 pounds of the grain mix along with a dark green feed particle (L*29.13, a* −5.16, b*12.28). For the TMR study, test pans contained 5 pounds of the TMR along with the dark green feed particle (L*29.13, a* −5.16, b*12.28). Pans were removed and weighed to determine feed consumed.

Comparisons

| | Ration 1 | Ration 2 |
|---|---|---|
| Grain Mixes | | |
| Acclimation | Grain Mix A | Grain Mix A |
| Test 1 | Grain Mix A | Grain Mix B |
| TMR Mixes | | |
| Acclimation | Grain Mix A | Grain Mix A |
| Test 2 | Grain Mix A | Grain Mix B |

Grain Mixes:

| | Ration | | Grain mix, pounds |
|---|---|---|---|
| Treatment, | Description: Iso-fat | Particle, | as fed (e.g., corn, |
| Ration | (~8% added fat) | pounds as fed | soybean meal) |
| Grain Mix A | Control Particle | 0.50 | 4.5 |
| Grain Mix B | Dark green Particle | 0.50 | 4.5 |

TMR Mixes:

| | | | | | Grain mix |
|---|---|---|---|---|---|
| Pounds | | | | | (e.g., |
| of as | | | | | corn, |
| fed | Ration | Corn | Alfalfa | | soybean |
| (lbs.) | Description | Silage | Hay | Feed Particle | meal) |
| TMR A | Control Particle | 2.5 | 0.5 | 0.2 control | 1.8 |
| TMR B | Dark green | 2.5 | 0.5 | 0.2 dark green | 1.8 |
| | Particle | | | | |

Results:

Adaptation intakes:

| | Left Control | Right Control | | |
|---|---|---|---|---|
| | Particle ration | Particle ration | | Side Effect (p- |
| | consumed (lb.) | consumed (lb.) | SE | value) |
| TMR | 1.23 | 1.26 | 0.15 | 0.65 |
| Adaptation | | | | |
| Grain | 0.99 | 0.98 | 0.19 | 0.95 |
| Adaptation | | | | |

Treatment intakes:

| | Control Particle | Green Particle | | Treatment |
|---|---|---|---|---|
| | ration consumed | ration consumed | | Effect (p- |
| | (lb.) | (lb.) | SE | value) |
| TMR Study | 1.99 | 1.82 | 0.16 | 0.26 |
| Grain Study | 0.86 | 1.08 | 0.13 | 0.14 |

Cows in this experiment experienced some native heat stress leading to reduced consumption. Although intakes were low, cows did consume test products and did not have a significant left/right bias.

Cows consumed TMR mixes containing the dark green test particle equal to rations containing control product. There was a trend for cows to eat more of the grain mix containing dark green test particle compared to the control particle; however it was not statistically significant (p-value=0.14) and the effect was lost when mixed into a TMR. Overall, the results of the studies indicate cow preference for the feed particle is not altered by changing the color to dark green. The feed particle may be dyed with the colorants of the present disclosure without negatively impacting consumption in a TMR or in component fed systems. Instead, in the component fed systems, the colored feed particle may increase consumption.

While the present disclosure provides various ranges, it will be understood that values, such as numeric integer values, at or within these ranges, or various ranges within the disclosed ranges, or ranges beginning or ending at a range value and beginning or ending at a value within the disclosed ranges may be used in particular embodiments without departing from the invention. For example, the percentage of saturated fat by weight of the total fat content within the animal feeds of the present disclosure may include any integer value from about 50 to about 100. In another example, the percentage of saturated fat by weight of the animal feed of the present disclosure may include any integer value from about 20 to about 55.

Although the present disclosure provides references to preferred embodiments, persons skilled in the art will recognize that changes may be made in form and detail without departing from the spirit and scope of the invention.

1-2. and 10-16. (canceled)

17. A method of forming a feed material adapted for deterring wild birds from consuming feed material otherwise susceptible to consumption by the wild birds, the method comprising:
forming an animal feed material comprising nutrients susceptible to wild bird consumption and a color that is effective to reduce the wild bird consumption of the animal feed,
wherein the color of the animal feed particle is one or more of:

| | | | |
|---|---|---|---|
| black iron oxide having approximate | 22.93, | 0.74, | 6.24, |
| respective L*a*b* values of: | | | |
| oxide having approximate respective | 41.77, | 5.48, | 26.11, |
| L*a*b* values of: | | | |
| tannin dye having approximate respective | 39.89, | 8.23, | 26.82, |
| L*a*b* values of: | | | |
| green having approximate respective | 36.04, | −11.58, | 18.07, or |
| L*a*b* values of: | | | |
| forest green having approximate respective | 29.13, | −5.16, | 12.28, |
| L*a*b* values of: | | | |

where L* is a measure of lightness approximately as the eye would evaluate it, and varies from 100 for perfect white to zero for black,
a* measures redness when positive, gray when zero and greenness when negative, and
b* measures yellowness when positive, gray when zero and blueness when negative.

18. The method of claim 17, wherein the animal feed material is formed by extruding or pelleting, and wherein a colorant is added to the feed material prior to extruding or pelleting.

19. The method of claim 17, wherein forming the animal feed material comprises spraying an exterior of the animal feed material with a colorant.

20. A method of deterring wild bird consumption of an animal feed particle, the method comprising:
in a location accessible to wild birds, providing non-avian animals an animal feed particle comprising nutrients susceptible to wild bird consumption and a color that is effective to reduce the wild bird consumption of the animal feed particle, the color of the animal feed particle being one or more of

| | | | |
|---|---|---|---|
| black iron oxide having approximate | 22.93, | 0.74, | 6.24, |
| respective L*a*b* values of: | | | |
| oxide having approximate respective | 41.77, | 5.48, | 26.11, |
| L*a*b* values of: | | | |
| tannin dye having approximate respective | 39.89, | 8.23, | 26.82, |
| L*a*b* values of | | | |
| green having approximate respective | 36.04, | −11.58, | 18.07, or |
| L*a*b* values of: | | | |
| forest green having approximate respective | 29.13, | −5.16, | 12.28, |
| L*a*b* values of: | | | |

where the L*a*b* values are based on a CIE 1976 L*a*b* color scale in which
L* is a measure of lightness approximately as the eye would evaluate it, and varies from 100 for perfect white to zero for black,
a* measures redness when positive, gray when zero and greenness when negative, and
b* measures yellowness when positive, gray when zero and blueness when negative.

21. The method of claim 20, wherein the wild bird consumption of the animal feed particle is reduced over a period of at least six consecutive hours.

22. The method of claim 20, wherein the wild bird consumption of the animal feed particle is reduced for at least 2 consecutive days when the particle is available for about 4 to 6 consecutive hours daily.

23. The method of claim 20, wherein the animal feed particle is provided in a feed ration to the non-avian animals ad libitum.

24. The method of claim 20, wherein the non-avian animals are livestock animals, wherein the animal feed particle is provided in a feed ration for the livestock animals, and the color of the animal feed particle is effective to reduce the wild bird consumption of the animal feed particle relative to other components in the feed ration for the livestock animals.

25. The method of claim 24, wherein the livestock animal is a ruminant.

26. The method of claim 20, wherein the location the animal feed particle is provided to the non-avian animals is one or more of an open setting, a semi-confined setting, or a confined setting.

27. A method of feeding non-avian animals, the method comprising:.
in a location accessible to wild birds, providing a feed ration to the non-avian animals, the feed ration comprising feed components and animal feed particles comprising nutrients susceptible to wild bird consumption and a color effective to reduce wild bird consumption of the animal feed particle.

28. The method of claim 27, wherein the color of the animal feed particle is one or more of:

| | | | |
|---|---|---|---|
| black iron oxide having approximate | 22.93, | 0.74, | 6.24, |
| respective L*a*b* values of: | | | |
| oxide having approximate respective | 41.77, | 5.48, | 26.11, |
| L*a*b* values of: | | | |
| tannin dye having approximate respective | 39.89, | 8.23, | 26.82, |
| L*a*b* values of: | | | |
| green having approximate respective | 36.04, | −11.58, | 18.07, or |
| L*a*b* values of: | | | |
| forest green having approximate respective | 29.13, | −5.16, | 12.28, |
| L*a*b* values of: | | | |

where L* is a measure of lightness approximately as the eye would evaluate it, and varies from 1.00 for perfect white to zero for black,
a* measures redness when positive, gray when zero and greenness when negative, and
b* measures yellowness when positive, gray when zero and blueness when negative.

29. New The method of claim 27, wherein the wild bird consumption of the animal feed particle is reduced relative to other feed components in the feed ration.

30. The method of claim 29, wherein the wild bird consumption of the animal feed particle is reduced over a period of at least six consecutive hours.

31. The method of claim 29, wherein the wild bird consumption of the animal feed particle is reduced for at least 2 consecutive days when the particle is available for about 4 to 6 consecutive hours daily.

32. The method of claim 27, wherein the location the feed ration is provided to the animals is one or more of a semi-confined setting or a confined setting.

33. The method of claim 27, wherein the non-avian animals are livestock animals.

34. The method of claim 33, wherein the livestock animals are ruminants.

35. The method of claim 27, wherein a consumption level of the feed rat:ion by the livestock animals is not negatively affected by the color of the feed particles.
